(19) United States
(12) Patent Application Publication
(10) Pub. No.: US 2003/0161286 A1
(43) Pub. Date: Aug. 28, 2003

(54) Spread spectrum multiple access codes and code groups generated by rotation transformation

(76) Inventor: Daoben Li, Beijing (CN)

Correspondence Address: Pennie & Edmonds, LLP, 3300 Hillview Avenue, Palo Alto, CA, 94304, US

(21) Appl. No.: 10/008,202

(22) Filed: Dec. 5, 2001

Related U.S. Application Data
(63) Continuation-in-part of application No. PCT/CN00/00092, filed on Apr. 18, 2000.

(30) Foreign Application Priority Data
Jun. 26, 2000 (WO) PCT/CN00/00179

(51) Int. Cl. H04B 7/216

(52) U.S. Cl. 370/335; 375/130

(57) ABSTRACT

A method for forming an orthogonal code group for use in a spread spectrum communication system is disclosed. The orthogonal code group can be formed by orthogonal rotation of a nonzero real number and complex number sequence. Multiple groups of orthogonal codes can also be obtained by orthogonal rotation of a given orthogonal code group as long as the given code group includes real number and/or complex number elements. Every code within a code group thus formed is substantially orthogonal with other codes within the code group. Furthermore, the code groups thus formed retain desirable characteristics of the initial code group.

The present application is a continuation-in-part of, and claims priority under 35 U.S.C. §§ 120 and 365(c) to co-pending PCT application bearing application number PCT/CN00/00092, filed Apr. 18, 2000, and designating multiple countries including the United States, but was not published in English under PCT Article 21(2).

### RELATED APPLICATIONS

The present application is related to PCT application bearing PCT/CN00/00179, filed Jun. 26, 2000, and co-pending United States patent application entitled “Generation of Spread Spectrum Multiple Access Codes with Zero-Correlation Windows”, filed herewith and bearing attorney docket number 10748-0004-999. The aforementioned United States patent application is hereby incorporated by reference in its entirety.

### FIELD OF THE INVENTION

The present invention relates generally to wireless spread spectrum technology and digital mobile communication technology, and more particularly to a method for generating spread spectrum multiple access codes, and a method of orthogonal transformation between multiple access code groups.

### BACKGROUND OF THE INVENTION

Spread spectrum technology, particularly code division multiple access (CDMA) technology, has become increasingly important in wireless communication because spread spectrum technology can provide a larger system capacity than other multiple access methods.

In a spread spectrum communication system, the selection of multiple access code directly influences the system's capacity, interference cancellation, access speed and switching speed, etc. Each user in a spread spectrum communication system has his own special spread spectrum multiple access code for addressing and multiple access purposes. Generally speaking, within a cell (or sector), spread spectrum multiple access codes assigned to different users have the property that they are completely orthogonal or nearly completely orthogonal with each other, that is, the sum of the products of each element of one code with the corresponding element of the other code equals to or approaches zero. At the same time, spread spectrum multiple access codes used in one cell should also be as orthogonal with those used in a different cell as possible. This is not only for identifying cells (or sector) and users, but also for reducing interference between neighbor cells (or sector) and among user channels. This is because a user station usually receives not only signals from its own cell's base station, but also signals from its neighboring cells. Therefore, for any system based on the code division multiple access (CDMA) technology, the spread spectrum multiple access codes used in neighboring cells (or sector) should be as orthogonal as possible. The orthogonality property is usually described mathematically by the correlation function between multiple access codes. The smaller the value of the correlation function, the better is the orthogonality and the larger is the difference between two spread spectrum multiple access codes.

At present, the most popular method for generating spread spectrum multiple access codes for use in different cells is to scramble the basic orthogonal spread spectrum multiple access codes using different offsets of a long pseudorandom (PN) sequence. A different offset of the long PN sequence is used in different cells. For example, consider the following four mutually and completely orthogonal spread spectrum multiple access codes:

$$\begin{matrix}+ & + & + & + \\ + & - & + & - \\ + & + & - & - \\ + & - & - & +\end{matrix}$$

In the example above, “+” represents digital +1 and “−” represents digital −1; and, each row represents a basic spread spectrum multiple access code. As is evident from comparison of the codes, each code is orthogonal with every other code, because the sum of products of each element of one code with the corresponding element of every other code is zero.

When these codes are scrambled by multiplying them with −+++ and +++−, respectively, the following two groups of spread spectrum multiple access codes are generated:

$$\begin{matrix}\begin{matrix}- & + & + & + \\ - & - & + & - \\ - & + & - & - \\ - & - & - & +\end{matrix} ( scrambled by - ++ + ) , and & Group 1 \\ \begin{matrix}+ & + & + & - \\ + & - & + & + \\ + & + & - & + \\ + & - & - & -\end{matrix} ( scrambled by ++ + - ) . & Group 2\end{matrix}$$

Since the scrambling process performs the same operation on each element at the same position in a code word, the relation among the elements at the same position in any intra-group pair of code words is not changed by the scrambling process. As a result, within each of the two newly produced groups of spread spectrum multiple access codes, the spread spectrum multiple access codes within each group remain completely orthogonal with each other. But as between the two groups, since different scrambling functions were used, the relation among the elements at the same position in any inter-group pair of code words will change at those locations where the scrambling codes differ. As a result, code words in Group 1 may no longer be completely orthogonal with code words in Group 2. For example, the code word −−+− is not orthogonal with the code word ++−+.

The scrambling transformation approach, although effective in generating groups of orthogonal multiple access codes, has the following disadvantages:

1. The code groups obtained by scrambling may not retain the non-periodic auto-correlation and cross-correlation characteristics of the initial code group.

2. Some codes in the initial code group may not be completely orthogonal with codes obtained by scrambling.

3. Scrambling will result in non-orthogonal codes if the codes of the initial code group are not orthogonal with each other. Thus, the initial orthogonal code group must be carefully chosen.

Accordingly, there exists a need for a method and apparatus for generating the spread spectrum multiple access codes without the above-mentioned disadvantages.

### SUMMARY OF THE INVENTION

The present invention provides a method and apparatus for generating spread spectrum multiple access codes that is more advanced than the scrambling transformation approach. According to some embodiments of the invention, a real number or complex number sequence of any length can be used to form orthogonal groups of spread spectrum multiple access codes. An initial code group may be used to form code groups that retain the non-periodic auto-correlation and cross-correlation characteristics of the initial code group. Furthermore, codes in the code groups obtained according to embodiments of the present invention are completely orthogonal with each other and with codes in the initial code group.

The present invention, in some embodiments, provides a method and apparatus for generating groups of spread spectrum multiple access codes from an initial group of codes. After the transformation, the resulting code groups retain the correlation characteristics of the initial code group. These characteristics include periodic, non-periodic and hybrid auto-correlation characteristics; and periodic, non-periodic and hybrid cross-correlation characteristics. The codes of the resulting code groups and the codes of the initial code group are mutually orthogonal if the codes in the initial code group are substantially orthogonal with each other.

An embodiment of the present invention is a method of generating a spread spectrum multiple access code using orthogonal rotation that includes the following steps:

Select a nonzero sequence with N elements, a₀=[a₀₀, a₀₁, a₀₂, . . . , a_{0N-1}], where N≧2.

Select a set of basic rotation angles α₁, α₂, . . . α_{N-1} each of which is applied to a corresponding element of the sequence a₀. The sum of the basic rotation angles equals 2nπ, where n is an integer.

Rotate the sequence a₀ by an integer multiple of the basic rotation angles to form a new sequence. Using different integers between 1 and N−1, the sequence a₀ may be rotated (N−1) times to obtain (N−1) new sequences.

Together with the initial sequence a₀, the following N sequences result:

$$\begin{matrix}{a}_{0} = [ {a}_{00} , {a}_{01} , {a}_{02} , … , {a}_{0 N - 1} ] \\ {a}_{1} = [ {a}_{00} , {a}_{01} , {ⅇ}^{{jα}_{1}} , {a}_{02} {ⅇ}^{{jα}_{2}} , … , {a}_{0 N - 1} {ⅇ}^{{jα}_{N - 1}} ] \\ {a}_{2} = [ {a}_{00} , {a}_{01} , {ⅇ}^{{j2α}_{1}} , {a}_{02} {ⅇ}^{{j2α}_{2}} , … , {a}_{0 N - 1} {ⅇ}^{{j2α}_{N - 1}} ] \\ ⋮ \\ {a}_{N - 1} = [ {a}_{00} , {a}_{01} {ⅇ}^{j ( N - 1 ) {α}_{1}} , {a}_{02} {ⅇ}^{j ( N - 1 ) {α}_{2}} , … , {a}_{0 N - 1} {ⅇ}^{j ( N - 1 ) {α}_{N - 1}} ]\end{matrix}$$

The above sequences are mutually orthogonal and constitute an orthogonal spread spectrum multiple access code group.

Another embodiment of the present invention is a method based on orthogonal rotation for generating a spread spectrum multiple access code group. In this embodiment, the method includes the following steps:

Take an orthogonal code group with M sequences each having N elements,

$${B}^{{T}_{0}} = [ \begin{matrix}{b}_{0}^{{T}_{0}} \\ {b}_{1}^{{T}_{0}} \\ ⋮ \\ {b}_{m}^{{T}_{0}} \\ ⋮ \\ {b}_{M - 1}^{{T}_{0}}\end{matrix} ] ,$$

where

bₘ^{T}^{₀}=[bₘ₀, bₘ₁, bₘ₂, . . . , b_{mN-1}], m=0, 1, 2, . . . , M−1.

Select a set of basic rotation angles α₁, α₂, . . . , α_{N-1} each of which is applied to a corresponding elements of the code group. The sum of the basic rotation angles equals 2nπ.

Rotate each element of the code group by the same integer multiple of an associated one of the basic rotation angles to form a new orthogonal code group.

Using different integer multiples between 1 and N−1, the orthogonal code group B^{T}^{₀} may be rotated (N−1) times to form (N−1) new orthogonal code groups. Together with the initial code group, the following N orthogonal code groups result:

B^{T}^{₀}, B^{T}^{₁}, B^{T}^{₂}, . . . , B^{T}^{_{N-1}},

where B^{T}^{ₙ}=

$${B}^{{T}_{n}} = [ \begin{matrix}{b}_{0}^{{T}_{n}} \\ {b}_{1}^{{T}_{n}} \\ ⋮ \\ {b}_{m}^{{T}_{n}} \\ ⋮ \\ {b}_{M - 1}^{{T}_{n}}\end{matrix} ] ,$$

bₘ^{T}^{ₙ}=[bₘ₀, bₘ₁e^{jnα}^{₁}, bₘ₂e^{jnα}^{₂}, . . . , b_{mN-1}e^{jnα}^{_{N-1}}], n=0, 1, . . . , N−1 m=0, 1, . . . , M−1.

According to one embodiment of the invention, any nonzero real number or any nonzero complex number sequence can be used to generate an orthogonal code group for use in a spread spectrum communication system when appropriate rotations are applied. Also, according to one embodiment, any real number or complex number orthogonal code group can be used to generate multiple orthogonal code groups. The resulting code groups retain the same non-periodic auto-correlation and cross-correlation characteristics of the initial code group. Furthermore, the resulting code groups can satisfy various requirements of a spread spectrum multiple access communication system.

Embodiments of the present invention can be used to generate orthogonal spread spectrum multiple access code groups for use in different cells (or sectors) of a cell-based or sector-based spread spectrum multiple access communication system. The present invention offers an effective solution for network planning, switching and capacity enhancement, etc., of spread spectrum communication systems. Additionally, by applying the rotation transformation multiple times, an orthogonal code group can be quickly generated from a nonzero real number sequence or a complex number sequence of any length. The present invention, which is simple and effective, can replace the complex conventional methods for generating orthogonal codes.

### BRIEF DESCRIPTION OF THE DRAWINGS

For a better understanding of the invention, reference should be made to the following detailed description taken in conjunction with the accompanying drawings, in which:

FIG. 1 depicts a cellular network that uses orthogonal code groups in accordance with an embodiment of the present invention.

FIG. 2 depicts a cell within a celluar network that uses orthogonal codes in accordance with an embodiment of the present invention.

FIG. 3 is a block diagram of a transmitter that uses orthogonal codes in accordance with one embodiment of the present invention.

FIG. 4 is a block diagram of a transmitter that uses orthogonal codes in accordance with another embodiment of the present invention.

FIG. 5 is a block diagram of a receiver that uses orthogonal codes in accordance with another embodiment of the present invention.

FIG. 6 is a block diagram of a receiver that uses orthogonal codes in accordance with another embodiment of the present invention.

### DESCRIPTION OF THE PREFERRED EMBODIMENTS

Preferred embodiments of the present invention are described below.

An embodiment of the present invention is an orthogonal rotation method for generating a group of orthogonal codes based on a code sequence. According to this embodiment, a first code sequence is chosen. Then, a plurality of basic rotation angles for the elements of the first sequence are defined. The elements are then rotated by an integer multiple of the defined basic rotation angles to form a second sequence. According to the present embodiment, the second code sequence thus generated will be orthogonal with the initial sequence. The rotation transformation may be performed multiple times with different integer multiples to form a group of orthogonal code sequences.

As an example, suppose there is a binary sequence with a length of 3 elements, +++. In accordance with the present example, three rotation angles α₀, α₁ and α₂ are chosen. In this example, α₀ is chosen to be 0, α₁, is chosen to be 2π/3, and α₂ is chosen to be 4π/3. Then, each element of the binary sequence is rotated by the corresponding rotation angles in the complex plane. That is, the first element is rotated by α₀(0), the second element is rotated by α₁(2π/3), and the third element is rotated by α₂(4π/3, or, equivalently, −2π/3), respectively, in the complex plane. As a result, a new sequence (+e^{j2π/3}e^{-j2π/3}) is produced.

Then, each element of the binary sequence is rotated by an integer multiple of the rotation angles α₀, α₁, and α₂. When the integer multiple is two, each element of the binary sequence is rotated by two times the corresponding rotation angle. So, the first element is rotated by 2×α₀(0), the second element is rotated by 2×α₁(4π/3 or, equivalently, −2π/3), and the third element by 2×α₂(8π/3 or, equivalently, 2π/3), respectively, in the complex plane. As a result, another new sequence, (+e^{-j2π/3}e^{j2π/3}), is produced. In this example, it is meaningless to apply three or more cycles of rotation because additional cycles of rotation do not produce any new sequence. Therefore, after applying two cycles of rotation on the sequence (+++), a code group is obtained:

Basic sequence=[+++];

Rotate one cycle=[+e^{j2π/3}e^{-j2π/3}];

Rotate two cycles=[+e^{-j2π/3}e^{j2π/3}].

This code group, formed by orthogonal rotation, is an orthogonal code group. As used herein, an orthogonal code group includes codes that are completely or nearly orthogonal with each other, that is, the sum of the products of each element of one code with the corresponding element (in some cases, the complex conjugate of the corresponding element) equals or approximately equals zero. In the above example, the code [+e^{j2π/3}e^{-j2π/3}] is orthogonal to [+e^{-j2π/3}e^{j2π/3}] because the sum of the products of each element of [+e^{j2π/3}e^{-j2π/3}] with the complex conjugate of the corresponding element of [+e^{-j2π/3}e^{j2π/3}] equals zero.

Note that the orthogonality of the code sequences is totally independent of their initial phases. For instance, consider the following code sequences with initial phrases of φ₀, φ₁ and φ₂:

$$\begin{matrix}{C}_{0} ( {ϕ}_{0} ) = [ {ⅇ}^{{jϕ}_{0}} {ⅇ}^{{jϕ}_{0}} {ⅇ}^{{jϕ}_{0}} ] \\ {C}_{1} ( {ϕ}_{1} ) = [ {ⅇ}^{{jϕ}_{1}} {ⅇ}^{j ( {ϕ}_{1} + \frac{2 π}{3} )} {ⅇ}^{j ( {ϕ}_{1} - \frac{2 π}{3} )} ] \\ {C}_{2} ( {ϕ}_{2} ) = [ {ⅇ}^{{jϕ}_{2}} {ⅇ}^{j ( {ϕ}_{2} \frac{2 π}{3} )} {ⅇ}^{j ( {ϕ}_{2} + \frac{2 π}{3} )} ]\end{matrix}$$

Observe that, for any initial phase φ₀, φ₁ and φ₂, the codes C₀(φ₀), C₁(φ₁) and C₂(φ₂) remain orthogonal with each other. Because of their orthogonal characteristics, these codes can be adapted for use in a spread spectrum communication systems.

Attention now turns to the auto-correlation characteristics of the code sequences generated according to embodiments of the present invention. Auto-correlation refers to the degree of correspondence between a sequence and a phased-shifted replica of itself. An auto-correlation function for a signal x(t), in general, is defined as:

$${R}_{x} ( τ ) = {\int }_{- ∞}^{∞} x ( t ) x ( t + τ ) ⅆ t$$

In some embodiments of the present invention, an auto-correlation function of a code sequence is the sum of the products of each element of the code sequence with the complex conjugate of the corresponding element of a phase-shifted replica of the code sequence. Table 1 illustrates the non-periodic auto-correlation functions of the code sequences C₀(φ₀), C₁(φ₁) and C₂(φ₂).

TABLE 1
$\begin{matrix}Non \text{-} periodic auto \text{-} correlation functions of {C}_{0} ( {ϕ}_{0} ) = [ {ⅇ}^{{jϕ}_{0}} {ⅇ}^{{jϕ}_{0}} {ⅇ}^{{jϕ}_{0}} ] \\ {C}_{1} ( {ϕ}_{1} ) = [ \begin{matrix}{ⅇ}^{{jϕ}_{1}} & {ⅇ}^{j ( {ϕ}_{1} + \frac{2 π}{3} )} & {ⅇ}^{j ( {ϕ}_{1} - \frac{2 π}{3} )}\end{matrix} ] \\ {C}_{2} ( {ϕ}_{2} ) = [ \begin{matrix}{ⅇ}^{{jϕ}_{2}} & {ⅇ}^{j ( {ϕ}_{2} - \frac{2 π}{3} )} & {ⅇ}^{j ( {ϕ}_{2} + \frac{2 π}{3} )}\end{matrix} ]\end{matrix}$

| | −2 | −1 | 0 | 1 | 2 |
|---|---|---|---|---|---|
| ${R}_{{C}_{0}} ( τ )$ | 1 | 2 | 3 | 2 | 1 |
| ${R}_{{C}_{1}} ( τ )$ | ${ⅇ}^{\frac{j2π}{3}}$ | $2 {ⅇ}^{\frac{- j2π}{3}}$ | 3 | $2 {ⅇ}^{\frac{j2π}{3}}$ | ${ⅇ}^{\frac{- j2π}{3}}$ |
| ${R}_{{C}_{2}} ( τ )$ | ${ⅇ}^{\frac{- j2π}{3}}$ | $2 {ⅇ}^{\frac{j2π}{3}}$ | 3 | $2 {ⅇ}^{\frac{- j2π}{3}}$ | ${ⅇ}^{\frac{j2π}{3}}$ |

As shown in Table 1, the auto-correlation functions R_{c}_{⁰}(τ), R_{c}_{¹}(τ) and R_{c}_{²}(τ) are substantially consistent with each other except at the side lobes where some fixed phase shifts occur. The characteristic that the auto-correlation functions R_{c}_{⁰}(τ), R_{c}_{¹}(τ) and R_{c}_{²}(τ) are substantially consistent with each other except at the side lobes is also desired in some spread spectrum communication systems.

In the following, the effects of rotation transformation on the orthogonality or bi-orthogonality orthogonality of a spread spectrum code group are described. Consider the following ternary code group {C₀, C₁, C₂, C₃}:

C₀=[+++]

C₁=[+−−]

C₂=[−−+]

C₃=[−+−]

Table 2 is a table showing the non-periodic auto-correlation and cross-correlation function of this code group. Cross-correlation refers to the degree of correspondence between two sequences. A cross-correlation function between two different signals, x(t) and y(t), in general, is given as

$${R}_{c} ( τ ) = {\int }_{- ∞}^{∞} x ( τ ) y ( t + τ ) ⅆ t$$

In some embodiments of the present invention, a cross-correlation function between a first code sequence and a second code sequence is the sum of the products of each element of first code sequence with the complex conjugate of the corresponding element of a phase-shifted replica of the second code sequence.

TABLE 2
Non-periodic auto-correlation and cross-correlation functions of
C₀ = [+ + +]; C₁ = [+ − −];
C₂ = [− − +]; C₃ = [− + −]

| | −2 | −1 | 0 | 1 | 2 |
|---|---|---|---|---|---|
| R_{C}_{₀} (τ) | 1 | 2 | 3 | 2 | 1 |
| R_{C}_{₁} (τ) | −1 | 0 | 3 | 0 | −1 |
| R_{C}_{₂} (τ) | −1 | 0 | 3 | 0 | −1 |
| R_{C}_{₃} (τ) | 1 | −2 | 3 | −2 | 1 |
| R_{C}_{₀}_{C}_{₁} (τ) | −1 | −2 | −1 | 0 | 1 |
| R_{C}_{₀}_{C}_{₂} (τ) | 1 | 0 | −1 | −2 | −1 |
| R_{C}_{₀}_{C}_{₃} (τ) | −1 | 0 | −1 | 0 | −1 |
| R_{C}_{₁}_{C}_{₂} (τ) | 1 | −2 | −1 | 2 | 1 |
| R_{C}_{₁}_{C}_{₃} (τ) | −1 | 2 | −1 | 0 | 1 |
| R_{C}_{₂}_{C}_{₃} (τ) | 1 | 0 | −1 | 2 | −1 |

When rotated according to embodiments of the invention, the multiple access code group {C₀, C₁, C₂, C₃} produces the following three groups of multiple access codes.

$$\begin{matrix}{C}_{0}^{{T}_{0}} = [ ++ + ] & {C}_{0}^{{T}_{1}} = [ + {ⅇ}^{j2π / 3} {ⅇ}^{- j2π / 3} ] & {C}_{0}^{{T}_{2}} = [ + {ⅇ}^{- j2π / 3} {ⅇ}^{j2π / 3} ] \\ {C}_{1}^{{T}_{0}} = [ + -- ] & {C}_{1}^{{T}_{1}} = [ + {ⅇ}^{- jπ / 3} {ⅇ}^{jπ / 3} ] & {C}_{1}^{{T}_{2}} = [ + {ⅇ}^{jπ / 3} {ⅇ}^{- jπ / 3} ] \\ {C}_{2}^{{T}_{0}} = [ -- + ] & {C}_{2}^{{T}_{1}} = [ - {ⅇ}^{- jπ / 3} {ⅇ}^{- j2π / 3} ] & {C}_{2}^{{T}_{2}} = [ - {ⅇ}^{jπ / 3} {ⅇ}^{j2π / 3} ] \\ {C}_{3}^{{T}_{0}} = [ - + - ] & {C}_{3}^{{T}_{1}} = [ - {ⅇ}^{j2π / 3} {ⅇ}^{jπ / 3} ] & {C}_{3}^{{T}_{2}} = [ - {ⅇ}^{- j2π / 3} {ⅇ}^{- jπ / 3} ] \\ ( initial code group ) & ( rotate one cycle ) & ( rotate two cycles )\end{matrix}$$

It is easy to verify that these codes, before and after rotation transformation, are thoroughly orthogonal, i.e., R_{C}_{₁}_{^{Tk}}_{C}_{₁}_{^{Tl}}(0)≡0 where i, k, l=0, 1, 2 k≠l. Four orthogonal code groups are formed by orthogonal rotation.

| | |
|---|---|
| Group 1 | Group 2 |
| ${C}_{0}^{{T}_{0}} = [ \begin{matrix}+ & + & +\end{matrix} ]$ | ${C}_{1}^{{T}_{0}} = [ \begin{matrix}+ & - & -\end{matrix} ]$ |
| ${C}_{0}^{{T}_{1}} = [ \begin{matrix}+ & {ⅇ}^{\frac{j2π}{3}} & {ⅇ}^{\frac{- j2π}{3}}\end{matrix} ]$ | ${C}_{1}^{{T}_{1}} = [ \begin{matrix}+ & {ⅇ}^{\frac{- jπ}{3}} & {ⅇ}^{\frac{jπ}{3}}\end{matrix} ]$ |
| ${C}_{0}^{{T}_{2}} = [ \begin{matrix}+ & {ⅇ}^{\frac{- j2π}{3}} & {ⅇ}^{\frac{j2π}{3}}\end{matrix} ] ;$ | ${C}_{0}^{{T}_{2}} = [ \begin{matrix}+ & {ⅇ}^{\frac{jπ}{3}} & {ⅇ}^{\frac{- jπ}{3}}\end{matrix} ]$ |
| Group 3 | Group 4 |
| ${C}_{2}^{{T}_{0}} = [ \begin{matrix}- & - & +\end{matrix} ]$ | ${C}_{3}^{{T}_{0}} = [ \begin{matrix}- & + & -\end{matrix} ]$ |
| ${C}_{2}^{{T}_{1}} = [ \begin{matrix}- & {ⅇ}^{\frac{- jπ}{3}} & {ⅇ}^{\frac{- j2π}{3}}\end{matrix} ]$ | ${C}_{3}^{{T}_{1}} = [ \begin{matrix}- & {ⅇ}^{\frac{j2π}{3}} & {ⅇ}^{\frac{jπ}{3}}\end{matrix} ]$ |
| ${C}_{2}^{{T}_{2}} = [ \begin{matrix}- & {ⅇ}^{\frac{jπ}{3}} & {ⅇ}^{\frac{j2π}{3}}\end{matrix} ] ;$ | ${C}_{3}^{{T}_{2}} = [ \begin{matrix}- & {ⅇ}^{\frac{- j2π}{3}} & {ⅇ}^{\frac{- jπ}{3}}\end{matrix} ]$ |

Tables 3 and 4 show the non-periodic auto-correlation and cross-correlation functions of the codes formed by the same number of rotation cycles. Table 3 shows the non-periodic auto-correlation and cross-correlation functions of C₀^{T}^{₁} C₁^{T}^{₁} C₂^{T}^{₁} and C₃^{T}^{₁}. Table 4 shows the non-periodic auto-correlation and cross-correlation functions of C₀^{T}^{₂} C₁^{T}^{₂} C₂^{T}^{₂} and C₃^{T}^{₂}. It can be seen from Tables 3 and 4 that, except for some fixed phase shifts at the side lobes of the correlation functions, the auto-correlation and cross-correlation functions of the codes of the initial code group are substantially consistent with those of the codes in the orthogonal-rotation generated code groups.

TABLE 3
$\begin{matrix}Non \text{-} periodic auto \text{-} correlation and cross \text{-} correlation functions of \\ \begin{matrix}{C}_{0}^{{T}_{1}} = [ \begin{matrix}+ & {ⅇ}^{\frac{j2π}{3}} & {ⅇ}^{\frac{- j2π}{3}}\end{matrix} ] & {C}_{1}^{{T}_{1}} = [ \begin{matrix}+ & {ⅇ}^{\frac{- jπ}{3}} & {ⅇ}^{\frac{jπ}{3}}\end{matrix} ] \\ {C}_{2}^{{T}_{1}} = [ \begin{matrix}- & {ⅇ}^{\frac{- jπ}{3}} & {ⅇ}^{\frac{- j2π}{3}}\end{matrix} ] & {C}_{3}^{{T}_{1}} = [ \begin{matrix}- & {ⅇ}^{\frac{j2π}{3}} & {ⅇ}^{\frac{jπ}{3}}\end{matrix} ]\end{matrix}\end{matrix}$

| | −2 | −1 | 0 | 1 | 2 |
|---|---|---|---|---|---|
| ${R}_{{C}_{0}} ( τ )$ | ${ⅇ}^{\frac{j2π}{3}}$ | $2 {ⅇ}^{\frac{- j2π}{3}}$ | 3 | $2 {ⅇ}^{\frac{j2π}{3}}$ | ${ⅇ}^{\frac{- j2π}{3}}$ |
| ${R}_{{C}_{1}} ( τ )$ | ${ⅇ}^{\frac{- jπ}{3}}$ | 0 | 3 | 0 | ${ⅇ}^{\frac{jπ}{3}}$ |
| ${R}_{{C}_{2}} ( τ )$ | ${ⅇ}^{\frac{- jπ}{3}}$ | 0 | 3 | 0 | ${ⅇ}^{\frac{jπ}{3}}$ |
| ${R}_{{C}_{3}} ( τ )$ | ${ⅇ}^{\frac{j2π}{3}}$ | $2 {ⅇ}^{\frac{jπ}{3}}$ | 3 | $2 {ⅇ}^{\frac{- jπ}{3}}$ | ${ⅇ}^{\frac{- j2π}{3}}$ |
| ${R}_{{C}_{0} {C}_{1}} ( τ )$ | ${ⅇ}^{\frac{- jπ}{3}}$ | ${ⅇ}^{\frac{- jπ}{3}}$ | −1 | 0 | ${ⅇ}^{\frac{- j2π}{3}}$ |
| ${R}_{{C}_{0} {C}_{2}} ( τ )$ | ${ⅇ}^{\frac{j2π}{3}}$ | 0 | −1 | $2 {ⅇ}^{\frac{- jπ}{3}}$ | ${ⅇ}^{\frac{jπ}{3}}$ |
| ${R}_{{C}_{0} {C}_{3}} ( τ )$ | ${ⅇ}^{\frac{- jπ}{3}}$ | 0 | −1 | 0 | ${ⅇ}^{\frac{jπ}{3}}$ |
| ${R}_{{C}_{1} {C}_{2}} ( τ )$ | ${ⅇ}^{\frac{j2π}{3}}$ | $2 {ⅇ}^{\frac{jπ}{3}}$ | −1 | $2 {ⅇ}^{\frac{j2π}{3}}$ | ${ⅇ}^{\frac{- j2π}{3}}$ |
| ${R}_{{C}_{1} {C}_{3}} ( τ )$ | ${ⅇ}^{\frac{- jπ}{3}}$ | $2 {ⅇ}^{\frac{- j2π}{3}}$ | −1 | 0 | ${ⅇ}^{\frac{- j2π}{3}}$ |
| ${R}_{{C}_{2} {C}_{3}} ( τ )$ | ${ⅇ}^{\frac{j2π}{3}}$ | 0 | −1 | $2 {ⅇ}^{\frac{jπ}{3}}$ | ${ⅇ}^{\frac{jπ}{3}}$ |

TABLE 4
$\begin{matrix}Non \text{-} periodic auto \text{-} correlation and cross \text{-} correlation functions of \\ \begin{matrix}{C}_{0}^{{T}_{2}} = [ \begin{matrix}+ & {ⅇ}^{\frac{- j2π}{3}} & {ⅇ}^{\frac{j2π}{3}}\end{matrix} ] & {C}_{1}^{{T}_{2}} = [ \begin{matrix}+ & {ⅇ}^{\frac{jπ}{3}} & {ⅇ}^{\frac{- jπ}{3}}\end{matrix} ] \\ {C}_{2}^{{T}_{2}} = [ \begin{matrix}- & {ⅇ}^{\frac{jπ}{3}} & {ⅇ}^{\frac{j2π}{3}}\end{matrix} ] & {C}_{3}^{{T}_{2}} = [ \begin{matrix}- & {ⅇ}^{\frac{- j2π}{3}} & {ⅇ}^{\frac{- jπ}{3}}\end{matrix} ]\end{matrix}\end{matrix}$

| | −2 | −1 | 0 | 1 | 2 |
|---|---|---|---|---|---|
| ${R}_{{C}_{0}} ( τ )$ | ${ⅇ}^{\frac{- j2π}{3}}$ | $2 {ⅇ}^{\frac{j2π}{3}}$ | 3 | $2 {ⅇ}^{\frac{- j2π}{3}}$ | ${ⅇ}^{\frac{j2π}{3}}$ |
| ${R}_{{C}_{1}} ( τ )$ | ${ⅇ}^{\frac{jπ}{3}}$ | 0 | 3 | 0 | ${ⅇ}^{\frac{- jπ}{3}}$ |
| ${R}_{{C}_{2}} ( τ )$ | ${ⅇ}^{\frac{jπ}{3}}$ | 0 | 3 | 0 | ${ⅇ}^{\frac{- jπ}{3}}$ |
| ${R}_{{C}_{3}} ( τ )$ | ${ⅇ}^{\frac{- j2π}{3}}$ | $2 {ⅇ}^{\frac{- jπ}{3}}$ | 3 | $2 {ⅇ}^{\frac{jπ}{3}}$ | ${ⅇ}^{\frac{j2π}{3}}$ |
| ${R}_{{C}_{0} {C}_{1}} ( τ )$ | ${ⅇ}^{\frac{jπ}{3}}$ | $2 {ⅇ}^{\frac{- jπ}{3}}$ | −1 | 0 | ${ⅇ}^{\frac{j2π}{3}}$ |
| ${R}_{{C}_{0} {C}_{2}} ( τ )$ | ${ⅇ}^{\frac{- j2π}{3}}$ | 0 | −1 | $2 {ⅇ}^{\frac{jπ}{3}}$ | ${ⅇ}^{\frac{- jπ}{3}}$ |
| ${R}_{{C}_{0} {C}_{3}} ( τ )$ | ${ⅇ}^{\frac{jπ}{3}}$ | 0 | −1 | 0 | ${ⅇ}^{\frac{- jπ}{3}}$ |
| ${R}_{{C}_{1} {C}_{2}} ( τ )$ | ${ⅇ}^{\frac{- j2π}{3}}$ | $2 {ⅇ}^{\frac{- jπ}{3}}$ | −1 | $2 {ⅇ}^{\frac{- j2π}{3}}$ | ${ⅇ}^{\frac{j2π}{3}}$ |
| ${R}_{{C}_{1} {C}_{3}} ( τ )$ | ${ⅇ}^{\frac{jπ}{3}}$ | ${ⅇ}^{\frac{jπ}{3}}$ | −1 | 0 | ${ⅇ}^{\frac{j2π}{3}}$ |
| ${R}_{{C}_{2} {C}_{3}} ( τ )$ | ${ⅇ}^{\frac{- j2π}{3}}$ | 0 | −1 | $2 {ⅇ}^{\frac{- j2π}{3}}$ | ${ⅇ}^{\frac{- jπ}{3}}$ |

As described above, an orthogonal code group can be formed by orthogonal rotation of a nonzero sequence of length N such as a₀=[a₀₀, a₀₁, a₀₂, . . . , a_{0N-1}]. In furtherance of an embodiment of the invention, if every element in the sequence a₀ₙ(n=0, 1, 2, . . . , N−1) is a real number with equal absolute value, or a complex number with equal modulus value (i.e., |a₀ₙ|² equals a constant), then a constant rotation can be applied.

In this embodiment, according to the code length the basic rotation angles are defined as

$${α}_{k} = \frac{2 k π}{N} ( k = {0}_{1} 1 , … N - 1 ) .$$

These basic rotation angles can be used to produce (N−1) new code sequences, including:

$$\begin{matrix}{a}_{1} = ( {ϕ}_{1} ) = [ {a}_{00} {ⅇ}^{{jϕ}_{1}} , {a}_{01} {ⅇ}^{j ( {ϕ}_{1} + α )} , {a}_{02} {ⅇ}^{j ( {ϕ}_{1} + 2 α )} , … , {a}_{0 N - 1} {ⅇ}^{j [ {ϕ}_{1} + ( N - 1 ) α ]} ] \\ {a}_{2} ( {ϕ}_{2} ) = [ {a}_{00} {ⅇ}^{{jϕ}_{2}} , {a}_{01} {ⅇ}^{j ( {ϕ}_{2} + 2 α )} , {a}_{02} {ⅇ}^{j ( {ϕ}_{2} + 4 α )} , … , {a}_{0 N - 1} {ⅇ}^{j [ {ϕ}_{2} + 2 ( N - 1 ) α ]} ] \\ ⋮ \\ {a}_{N - 1} ( {ϕ}_{N - 1} ) = [ {a}_{00} {ⅇ}^{{jϕ}_{N - 1}} , {a}_{01} {ⅇ}^{j ( {ϕ}_{N - 1} + ( N - 1 ) α )} , {a}_{02} {ⅇ}^{j ( {ϕ}_{N - 1} + 2 ( N - 1 ) α )} , … , {a}_{0 N - 1} {ⅇ}^{j [ {ϕ}_{N - 1} + {( N - 1 )}^{2} α ]} ] .\end{matrix}$$

The symbols φ₁, φ₂, . . . , φ_{N-1} represent initial phase angles. Furthermore, a₀ may also have an initial phase angle φ₀. That is,

a₀(φ₀)=[a₀₀e^{jφ}^{₀}, a₀₁e^{jφ}^{₀},a₀₂e^{jφ}^{₀}, . . . , a_{0N-1}e^{jφ}^{₀}].

Together with the initial sequence, there are N sequences: a₀(φ₀), a₁(φ₁), a₂(φ₂), . . . , a_{N-1}(φ_{N-1}). According to the present embodiment, these sequences constitute an orthogonal code group.

If |a₀ₙ|²(n=0, 1, 2, . . . , N−1) does not equal a constant, e.g., |a₀ₙ|² is not the same for all elements of a sequence, then it would be impossible to have a constant rotation. For simplicity, assuming there are no initial phase angles, N−1 new sequences are produced after orthogonal rotations. These sequences include:

$$\begin{matrix}{a}_{1} = [ {a}_{00} , {a}_{01} {ⅇ}^{{jα}_{1}} , {a}_{02} {ⅇ}^{{jα}_{2}} , … , {a}_{0 N - 1} {ⅇ}^{{jα}_{N - 1}} ] \\ {a}_{2} = [ {a}_{00} , {a}_{01} {ⅇ}^{{j2α}_{1}} , {a}_{02} {ⅇ}^{j 2 {α}_{2}} , … , {a}_{0 N - 1} {ⅇ}^{{j2α}_{N - 1}} ] \\ ⋮ \\ {a}_{N - 1} = [ {a}_{00} , {a}_{01} {ⅇ}^{j ( N - 1 ) {α}_{1}} , {a}_{02} {ⅇ}^{j ( N - 1 ) {α}_{2}} , … , {a}_{0 N - 1} {ⅇ}^{j ( N - 1 {α}_{N - 1}} ]\end{matrix}$$

The values of the basic rotation angles α₁ α₂ . . . α_{N-1} can be determined by solving the following set of equations:

$$\{ \begin{matrix}\vert {a}_{00} {\vert}^{2} + \vert {a}_{01} {\vert}^{2} {ⅇ}^{{jα}_{1}} + {\vert {a}_{02} \vert}^{2} {ⅇ}^{{jα}_{2}} + … + {\vert {a}_{0 N - 1} \vert}^{2} {ⅇ}^{{jα}_{N - 1}} = 0 \\ {\vert {a}_{00} \vert}^{2} + {\vert {a}_{01} \vert}^{2} {ⅇ}^{{j2α}_{1}} + {\vert {a}_{02} \vert}^{2} {ⅇ}^{{j2α}_{2}} + … + {\vert {a}_{0 N - 1} \vert}^{2} {ⅇ}^{{j2α}_{N - 1}} = 0 \\ ⋮ \\ {\vert {a}_{00} \vert}^{2} + {\vert {a}_{01} \vert}^{2} {ⅇ}^{j ( N - 1 ) {α}_{1}} + {\vert {a}_{02} \vert}^{2} {ⅇ}^{j ( N - 1 ) {α}_{2}} + … + {\vert {a}_{0 N - 1} \vert}^{2} {ⅇ}^{j ( N - 1 ) {α}_{N - 1}} = 0\end{matrix}$$

The set of equations have N−1 unknowns α₁, α₂, α_{N-1}. Since there are N−1 non-equivalent equations and N−1 unknowns, the equations are solvable. The initial phase of every sequence, φ₀, φ₁, φ₂, . . . , φ_{N-1}, does not affect the orthogonal rotation. Therefore, it is unnecessary to consider the initial phase angles when solving the equations.

According to another embodiment of invention, multiple orthogonal code groups can be generated from an initial orthogonal code group. In this embodiment, an orthogonal code group B^{To} with M sequences each having a length of N is chosen. By definition, the sequences of the orthogonal code group B^{To}, are orthogonal with each other.

$${B}^{{T}_{0}} = [ \begin{matrix}{b}_{0}^{{T}_{0}} \\ {b}_{1}^{{T}_{0}} \\ ⋮ \\ {b}_{m}^{{T}_{0}} \\ ⋮ \\ {b}_{M - 1}^{{T}_{0}}\end{matrix} ] ,$$

where bₘ^{T}^{₀}=[bₘ₀, bₘ₁, . . . , b_{mN-1}] and m=0, 1, 2, . . . , M−1.

Then, according to the present embodiment, a plurality of basic rotation angles are defined. Then, orthogonal rotations are applied to every sequence of the code group to generate a new code group.

The initial code group B^{To} can be rotated (N−1) times with (N−1) different integer multiples of the basic rotation angles to produce (N−1) new orthogonal code groups. Together with the initial code group B^{To}, there are N code groups:

B^{T}^{₀}, B^{T}^{₁}, B^{T}^{₂}, . . . , B^{T}^{_{N-1}},

$$where {B}^{{T}_{n}} = [ \begin{matrix}{b}_{0}^{{T}_{n}} \\ {b}_{1}^{{T}_{n}} \\ ⋮ \\ {b}_{M - 1}^{{T}_{n}}\end{matrix} ] , {b}_{m}^{{T}_{n}} = [ {b}_{m0} , {b}_{m1} {ⅇ}^{j n {α}_{2}} , {b}_{m2} {ⅇ}^{j n {α}_{2}} , … , {b}_{mN - 1} {ⅇ}^{j n {α}_{N - 1}} ] ,$$

n=0, 1, 2, . . . , N−1, and m=0, 1, 2, . . . , M−1.

Here, B^{T}^{ₙ}(n=0, 1, 2, . . . , N−1) represents the resulting code group after the n^{th} orthogonal rotation, and B^{T}^{₀} represents the initial code group. When every element of the sequence bₘ^{T}^{₀} is a real number with equal absolute value, or a complex number with equal modulus value (i.e., |bₘₙ|² equals a constant), or contains real number elements and complex number elements having the same modulus value, then a constant rotation can be applied. When constant rotation is applied, the basic rotation angles can be determined by:

$${α}_{k} = \frac{2 k π}{N} ,$$

where k=1, 2, . . . , N−1.

If |bₘₙ|² is not a constant, the basic rotation angles α₁ α₂ . . . α_{N-1} cannot be determined by the above formula. Rather, the basic rotation angles can be determined by solving the following set of equations:

$$\{ \begin{matrix}{\vert {b}_{m0} \vert}^{2} + {\vert {b}_{m1} \vert}^{2} {ⅇ}^{{jα}_{1}} + {\vert {b}_{m2} \vert}^{2} {ⅇ}^{{jα}_{2}} + … + {\vert {b}_{mN - 1} \vert}^{2} {ⅇ}^{{jα}_{N - 1}} = 0 \\ {\vert {b}_{m0} \vert}^{2} + {\vert {b}_{m1} \vert}^{2} {ⅇ}^{{j2α}_{1}} + {\vert {b}_{m2} \vert}^{2} {ⅇ}^{{j2α}_{2}} + … + {\vert {b}_{mN - 1} \vert}^{2} {ⅇ}^{{j2α}_{N - 1}} = 0 \\ ⋮ \\ \vert {b}_{m0} {\vert}^{2} + {\vert {b}_{m1} \vert}^{2} {ⅇ}^{j ( N - 1 ) {α}_{1}} + {\vert {b}_{m2} \vert}^{2} {ⅇ}^{j ( N - 1 ) {α}_{2}} + … + {\vert {b}_{mN - 1} \vert}^{2} {ⅇ}^{j ( N - 1 ) {α}_{N - 1}} = 0\end{matrix} ,$$

where m=0, 1, . . . , M−1.

Note that the solution of the equations is independent of m. Therefore, the above set of equations can be solved with any permissible value of m.

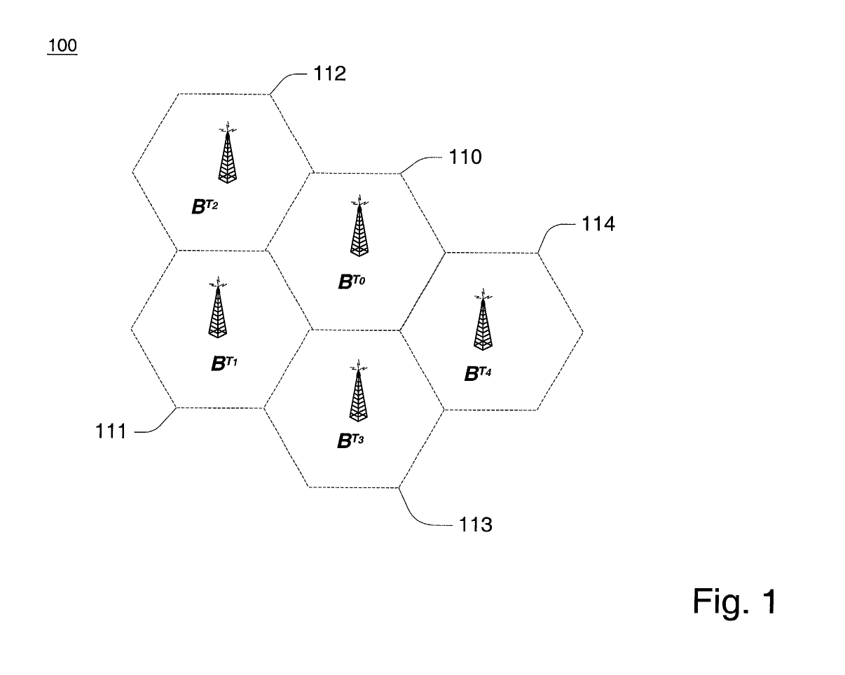

Orthogonal code groups generated according to embodiments of the present invention can be used in a wide variety of communication systems. For example, orthogonal code groups generated according to embodiments of the present invention can be used in a cellular wireless communication network in which a certain cell uses one orthogonal code group while other another cell use another orthogonal code group. FIG. 1 depicts a portion of such a wireless communication network 100 that has a number of cells 111-114 each using a different orthogonal code group. Specifically, as illustrated, cell 110 uses orthogonal code group B^{T0}, while cell 112 uses orthogonal code group B^{T2}, etc., where the code groups B^{T1}, B^{T2} . . . B^{T4} are generated according to embodiments of the present invention of B^{T0}, where

$${B}^{Tk} = [ \begin{matrix}{b}_{0}^{{T}_{k}} \\ {b}_{1}^{{T}_{k}} \\ ⋮ \\ {b}_{m}^{{T}_{k}} \\ ⋮ \\ {b}_{M - 1}^{{T}_{k}}\end{matrix} ] ,$$

bₘ^{T}^{ₖ}=[bₘ₀, bₘ₁e^{jkα}^{₂}, bₘ₂e^{jkα}^{₂}, . . . , b_{mN-1}e^{jkα}^{_{N-1}}], [bₘ₀, bₘ₁, bₘ₂, . . . , b_{mN-1}] denotes a base spread spectrum code, α₁, α₂, . . . , α_{N-1} denote a set of basic rotation angles, where k denotes an integer, and m denotes an integer smaller than M−1. As discussed above, provided the basic code group B^{T0} is an orthogonal code group, the code groups generated according to embodiments of the present invention will also be orthogonal code groups. Furthermore, the code groups thus generated retain desirable characteristics (e.g., auto-correlation and cross-correlation characteristics) of the initial code group B^{T0}.

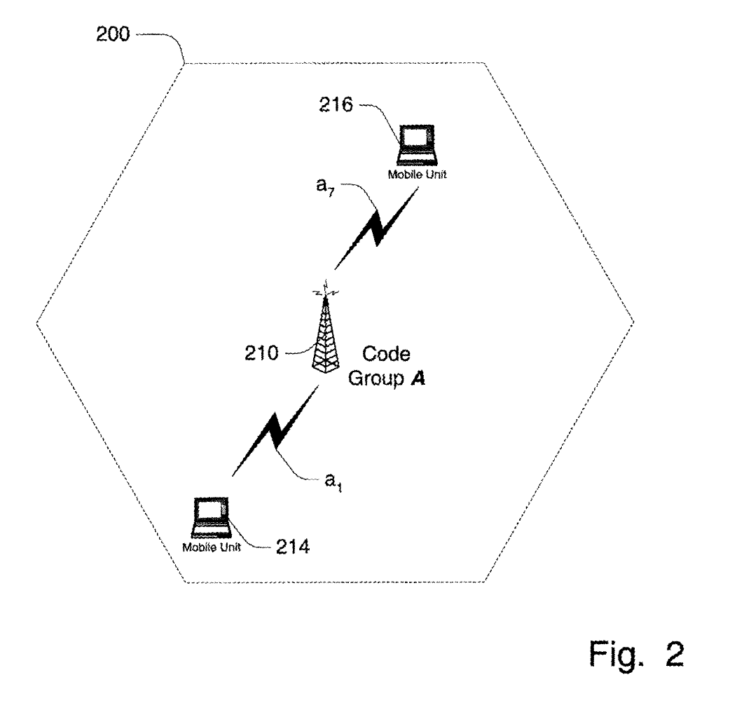

According to another embodiment of the present invention, codes generated according to embodiments of the present invention can be used within a same cell of a communication network. A cell 200 that uses an orthogonal code group A is illustrated in FIG. 2. In the present example, code sequences of the orthogonal code group A assume the form:

[a₀, a₁e^{jkα}^{₁}, a₂e^{jkα}^{₂}, . . . , a_{N-1}e^{jkα}^{_{N-1}}], where k=0, 1, 2 . . . , where [a₀, a₁, a₂, . . . , a_{N-1}] denotes a base spread spectrum code sequence, where α₁, α₂, . . . α_{N-1} denote a set of pre-defined basic rotation angles, and where k denotes an integer.

Also illustrated in FIG. 2 are base station 210 and two mobile units 214 and 216 located within the cell 200. While mobile unit 214 can communicate with base station 210 using one code a₁ of the orthogonal code group A, mobile unit 216 can communicate with the base station 210 using another code a₇ of the same orthogonal code group. Code a₁ and code a₇, which are generated according to embodiments of the present invention from a pre-determined code [a₀, a₁, a₂, . . . , a_{N-1}], are substantially orthogonal with each other and retain desirable characteristics of the pre-determined code. Because of their orthogonality, interference between the two communication channels is low.

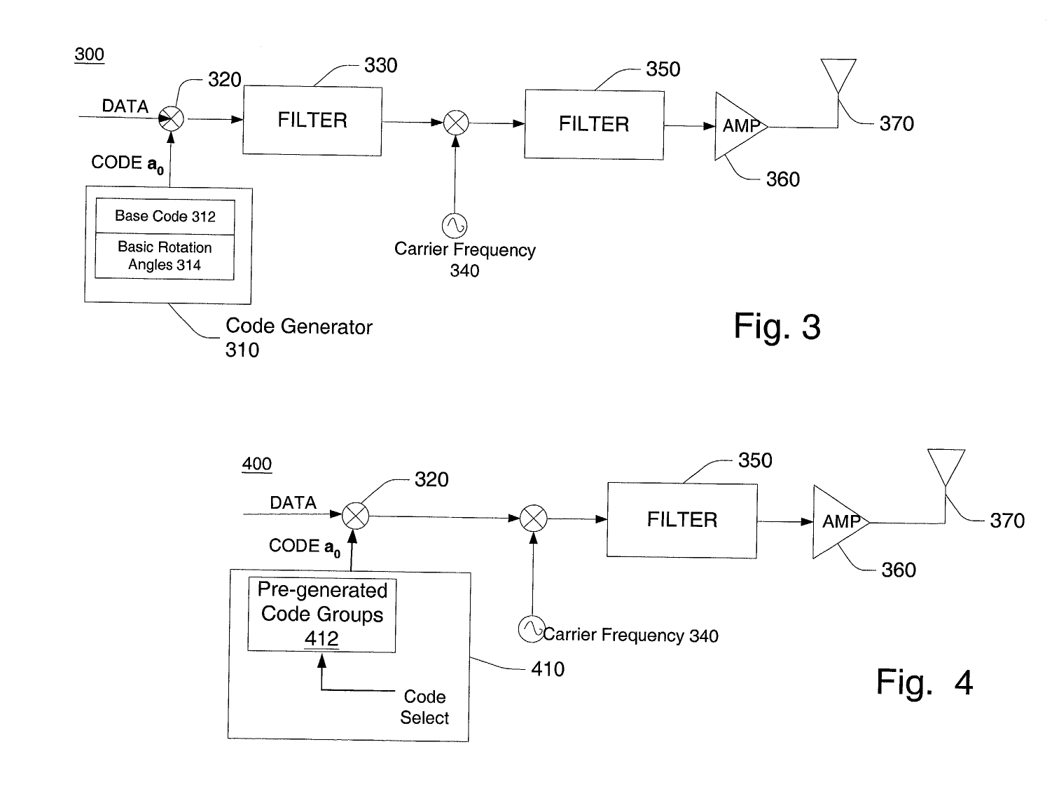

FIG. 3 depicts a block diagram of a transmitter 300 for a wireless communication system according to an embodiment of the present invention. The transmitter 300 may be implemented as part of a base station (e.g., base station 210) or a mobile station (e.g., mobile unit 214). As depicted, transmitter 300 includes a code generator 310 that stores a pre-determined code [a₀, a₁, a₂, . . . , a_{N-1}] (312) and a set of pre-determined basic rotation angles α₁, α₂, . . . , α_{N-1} (314). Using the pre-determined code, the pre-determined basic rotation angles, and embodiments of the orthogonal rotation process discussed above, the code generator 310 generates an orthogonally rotated code a₀ that includes the elements [a₀, a₁e^{jkα}^{₁}, a₂e^{jkα}^{₂}, . . . , a_{N-1}e^{jkα}^{_{N-1}}]. The code a₀ is then provided to a spreader circuit 320, which uses the code a₀ to spread the data to be transmitted. The spread data is then filtered by filter 330 and modulated by a carrier frequency 340. The modulated data is then filtered, amplified and transmitted via antenna 370. Note that the transmitter 300 of FIG. 3 has a configuration that is well known in the art. Many other configurations consistent with the scope and principles of the present invention are also possible.

With reference still to FIG. 3, different codes can be dynamically generated using different integer multiples of the basic rotation angles. Thus, the transmitter 300 may be dynamically configured to use codes that are not already used by other transmitters in the vicinity.

FIG. 4 depicts a block diagram of a simple transmitter 400 for a wireless communication system according to another embodiment of the present invention. The transmitter 400 does not use a code generator for generating the codes. Rather, the transmitter 400 uses a memory 410 having stored therein multiple code groups B^{T0}, B^{T1}, B^{T2} . . . B^{Tk} (412) that are generated according to embodiments of the present invention disclosed above. Selection signals can be used to select a particular one of the codes of the code groups to be used by the transmitter 400 to spread the data to be transmitted. In other respects, the components and the operation of transmitter 400 are the same s those of transmitter 300.

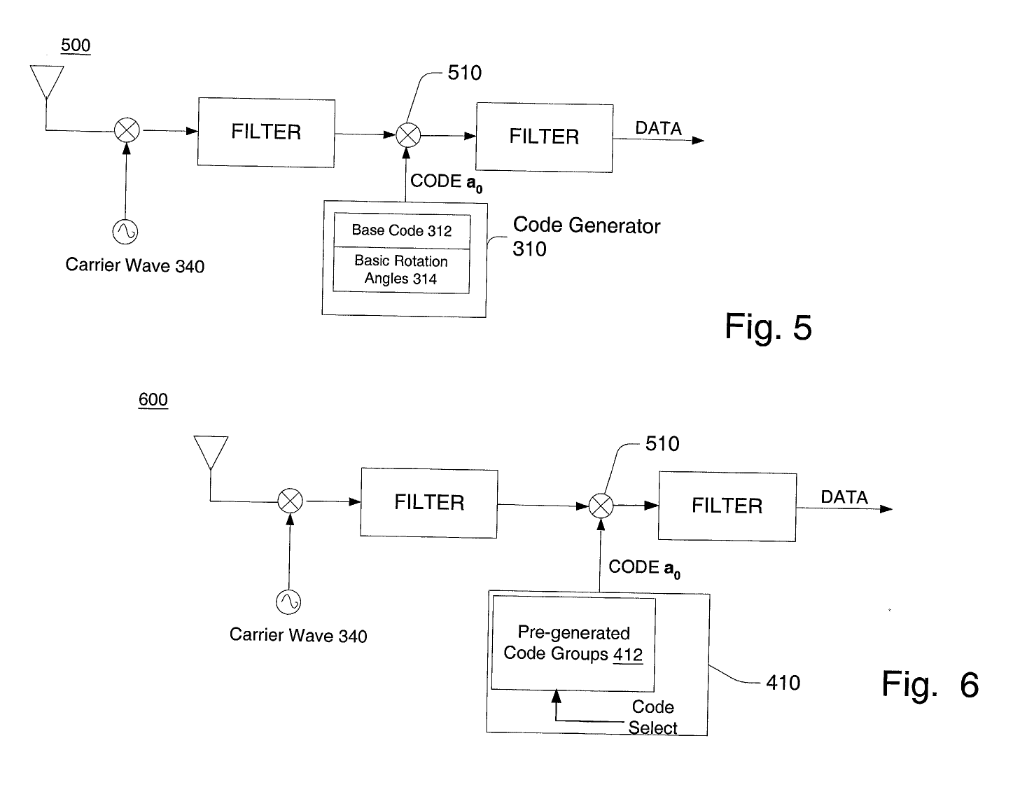

FIG. 5 depicts a block diagram of a receiver 500 for a wireless communication system according to an embodiment of the present invention. The receiver 500 may be used to receive data transmitted by transmitter 300 or 400, and may be implemented as part of a base station or a mobile station of the communication system. In FIG. 5, signals received by the receiver 500 are demodulated, and despread by a code a₀, which is generated by a code generator according to a pre-determined code [a₀, a₁, a₂, . . . , a_{N-1}] (312), a set of pre-determined basic rotation angles α₁, α₂, . . . , α_{N-1} (314), and embodiments of the orthogonal rotation process discussed above.

FIG. 6 depicts a block diagram of a receiver 600 for a wireless communication system according to another embodiment of the present invention. The receiver 600 may be used to receive data transmitted by transmitter 300 or 400, and may be implemented as part of a base station or a mobile station of the communication system. Pre-generated codes and/or code groups B^{T0}, B^{T1}, B^{T2} . . . B^{Tk} (412) are stored in a memory unit (410) of the receiver 600. In FIG. 6, a code a₀, which is one of the codes stored in the memory unit 410, is selected and used to despread received data. In other respects, the components and operation of receiver 600 are the same as those of receiver 500.

The foregoing description, for purposes of explanation, used specific nomenclature to provide a thorough understanding of the invention. However, it will be apparent to one skilled in the art that the specific details are not required in order to practice the invention. In other instances, well known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed, obviously many modifications and variations are possible in view of the above teachings. The embodiments were chosen and described to best explain the principles of the invention and its practical applications, to thereby enable others skilled in the art to best utilize the invention and various embodiments with various modifications as are suited to the particular use contemplated.

What is claimed is:

1. A method of generating codes for a spread spectrum multiple access system, comprising the steps of:
selecting a first code comprising [a₀, a₁, a₂, . . . , a_{N-1}], where N is an integer larger than one;
choosing a plurality of basic rotation angles comprising α₁, α₂, . . . , α_{N-1};
producing, from the first code and an integer multiple of the plurality of basic rotation angles, a second code that is substantially orthogonal with the first code, the second code comprising [a₀, a₁e^{jmα}^{₁}, a₂e^{jmα}^{₂}, . . . , a_{N-1}e^{jmα}^{_{N-1}}], wherein m is an integer.

2. The method of claim 1, wherein the producing step comprises (the step of) rotating elements of the first code according to the integer multiple of the plurality of basic rotation angles.

3. The method of claim 1, further comprising (the step of) producing, from the first code a₀ and integer multiples of the plurality of basic rotation angles, a plurality of codes each being orthogonal with the first code.

4. The method of claim 1, wherein the selecting step comprises selecting a code having real number elements each having a same absolute value.

5. The method of claim 1, wherein the selecting step comprises selecting a code having complex number elements each having a same modulus value.

6. The method of claim 1, wherein the selecting step comprises selecting a code having a real number element and a complex number element, the real number element having a same absolute value as a modulus value of the complex number element.

7. The method of claim 1, wherein the choosing step comprises choosing a plurality of rotation angles whose sum equals to an integer multiple of 2π.

8. The method of claim 1, wherein the choosing step comprises calculating the basic rotation angles α₁, α₂, . . . , α_{N-1} by:
$${α}_{k} = \frac{2 k π}{N} k = 1 , 2 , … , N - 1.$$

9. A method of generating codes to be used as an orthogonal code group by a spread spectrum multiple access system, the method comprising the steps of:
selecting a first code a₀ comprising [a₀, a₁, a₂, . . . , a_{N-1}];
choosing a plurality of basic rotation angles comprising α₁, α₂, . . . , α_{N-1};
producing, from elements of the first code a₀ and integer multiples of the plurality of basic rotation angles, a plurality of codes that are substantially orthogonal with the first code a₀, the plurality of codes comprising:
$$\begin{matrix}{a}_{1} = [ {a}_{0} , {a}_{1} {ⅇ}^{{jα}_{1}} , {a}_{2} {ⅇ}^{{jα}_{2}} , … , {a}_{N - 1} {ⅇ}^{{jα}_{N - 1}} ] \\ {a}_{2} = [ {a}_{0} , {a}_{1} {ⅇ}^{{j2α}_{1}} , {a}_{2} {ⅇ}^{{j2α}_{2}} , … , {a}_{N - 1} {ⅇ}^{{j2α}_{N - 1}} ] \\ ⋮ \\ {a}_{N - 1} = [ {a}_{0} , {a}_{1} {ⅇ}^{j ( N - 1 ) {α}_{1}} , {a}_{2} {ⅇ}^{j ( N - 1 ) {α}_{2}} , … , {a}_{N - 1} {ⅇ}^{j ( N - 1 ) {α}_{N - 1}} ] .\end{matrix}$$

10. The method of claim 9, wherein the producing step comprises (the step of) rotating elements of the first code a₀ by integer multiples of the plurality of basic rotation angles to produce the plurality of codes.

11. The method of claim 9, wherein the selecting step comprises selecting a code having real number elements each having a same absolute value.

12. The method of claim 9, wherein the selecting step comprises selecting a code having complex number elements each having a same modulus value.

13. The method of claim 9, wherein the selecting step comprises selecting a code having real number elements and complex number element, the real number elements having a same absolute value as a modulus value of the complex number elements.

14. The method of claim 9, wherein the choosing step comprises choosing a plurality of rotation angles whose sum equal to an integer multiple of 2π.

15. The method of claim 9, wherein the choosing step comprises calculating the basic rotating angles α₁, α₂, . . . , α_{N-1} by:
$$\begin{matrix}{α}_{k} = \frac{2 k π}{N} & k = 1 , 2 , ⋯ , N - 1\end{matrix} .$$

16. The method of claim 9, wherein the choosing step comprises determining a solution of:
$$\{ \begin{matrix}{\vert {a}_{00} \vert}^{2} + {\vert {a}_{01} \vert}^{2} {ⅇ}^{j {α}_{1}} + {\vert {a}_{02} \vert}^{2} {ⅇ}^{j {α}_{2}} + ⋯ + {\vert {a}_{0 N - 1} \vert}^{2} {ⅇ}^{j {α}_{N - 1}} = 0 \\ {\vert {a}_{00} \vert}^{2} + {\vert {a}_{01} \vert}^{2} {ⅇ}^{j 2 {α}_{1}} + {\vert {a}_{02} \vert}^{2} {ⅇ}^{j 2 {α}_{2}} + ⋯ + {\vert {a}_{0 N - 1} \vert}^{2} {ⅇ}^{j 2 {α}_{N - 1}} = 0 \\ ⋮ \\ {\vert {a}_{00} \vert}^{2} + {\vert {a}_{01} \vert}^{2} {ⅇ}^{j ( N - 1 ) {α}_{1}} + {\vert {a}_{02} \vert}^{2} {ⅇ}^{j ( N - 1 ) {α}_{2}} + ⋯ + {\vert {a}_{0 N - 1} \vert}^{2} {ⅇ}^{j ( N - 1 ) {α}_{N - 1}} = 0\end{matrix} .$$

17. A method of generating codes to be used as an orthogonal code group by a spread spectrum multiple access system, the method comprising the steps of:
selecting a first code a₀(φ₀) with an initial phase angle of φ₀, the first code a₀(φ₀) comprising [a₀₀e^{jφ}^{₀}, a₀₁e^{jφ}^{₀}, a₀₂e^{jφ}^{₀}, . . . , a_{0N-1}e^{jφ}^{₀}];
choosing a plurality of basic rotation angles comprising α₁, α₂, . . . , α_{N-1}; and
producing, from elements of the first code a₀(φ₀) and an integer multiple of the plurality of basic rotation angles, a second code having an initial phase angle of φ₁, wherein the second code a₁(φ₁) is substantially orthogonal with the first code a₀(φ₀), and wherein the second code a₁(φ₁) comprises [a₀₀e^{jφ}^{₁}, a₀₁e^{j(φ}^{₁}^{+mα}^{₁}⁾, a₀₂e^{j(φ}^{₁}^{+mα}^{₂}⁾, . . . , a_{0N-1}e^{j(φ+mα}^{_{N-1}}⁾].

18. The method of claim 17, wherein the producing step comprises (the step of) rotating elements of the first code a₀(φ₀) according to the integer multiple of the plurality of basic rotation angles.

19. The method of claim 17, further comprising (the step of) producing, from the first code a₀(φ₀) and integer multiples of the plurality of basic rotation angles, a plurality of codes each being orthogonal with the first code a₀(φ₀) and each having an initial phase shift.

20. A method for generating orthogonal code groups for a spread spectrum multiple access system, the method comprising the steps of:
selecting a first orthogonal code group B^{T0} with M sequences each having N elements, the first orthogonal code group B^{T0} comprising
$$[ \begin{matrix}{b}_{0}^{{T}_{0}} \\ {b}_{1}^{{T}_{0}} \\ ⋮ \\ {b}_{M - 1}^{{T}_{0}}\end{matrix} ] ,$$
where bₘ^{T}^{₀}=[bₘ₀, bₘ₁, bₘ₂, . . . , b_{mN-1}], m=0, 1, 2, . . . , M−1,
choosing a plurality of basic rotation angles comprising α₁, α₂, . . . , α_{N-1};
rotating elements of said M sequences by an integer multiple of the plurality of basic rotation angles to produce a second orthogonal code group B^{Tn} that comprises
$$[ \begin{matrix}{b}_{0}^{{T}_{n}} \\ {b}_{1}^{{T}_{n}} \\ ⋮ \\ {b}_{M - 1}^{{T}_{n}}\end{matrix} ] ,$$
where bₘ^{T}^{ₙ}=[bₘ₀bₘ₁e^{jnα}^{₂}, bₘ₂e^{jnα}^{₂}, . . . , b_{mN-1}e^{jnα}^{_{N-1}}], n=0, 1, . . . , N−1 and m=0, 1, . . . , M−1.

21. The method of claim 20, further comprising (the step of) producing, from the first orthogonal code group B^{T0} and integer multiples of the plurality of basic rotation angles, a plurality of code groups each being orthogonal with the first code orthogonal code group B^{T0}.

22. The method of claim 20, wherein the selecting step comprises selecting a code group having real number elements each having a same absolute value.

23. The method of claim 20, wherein the selecting step comprises selecting a code group having complex number elements each having a same modulus value.

24. The method of claim 20, wherein the selecting step comprises selecting a code group having real number elements and complex number elements, the real number elements having a same absolute value as a modulus value of the complex number elements.

25. The method of claim 20, wherein the choosing step comprises choosing a plurality of rotation angles whose sum equal to an integer multiple of 2π.

26. The method of claim 20, wherein the choosing step comprises calculating the basic rotation angles α₁, α₂, . . . , α_{N-1} by:
$$\begin{matrix}{α}_{k} = \frac{2 k π}{N} & k = 1 , 2 , ⋯ , N - 1\end{matrix} .$$

27. The method of claim 20, wherein the choosing step comprises determining a solution of:
$$\{ \begin{matrix}{\vert {b}_{m 0} \vert}^{2} + {\vert {b}_{m 1} \vert}^{2} {ⅇ}^{j {α}_{1}} + {\vert {b}_{m2} \vert}^{2} {ⅇ}^{j {α}_{2}} + ⋯ + {\vert {b}_{mN - 1} \vert}^{2} {ⅇ}^{j {α}_{N - 1}} = 0 \\ {\vert {b}_{m 0} \vert}^{2} + {\vert {b}_{m 1} \vert}^{2} {ⅇ}^{j 2 {α}_{1}} + {\vert {b}_{m 2} \vert}^{2} {ⅇ}^{j 2 {α}_{2}} + ⋯ + {\vert {b}_{mN - 1} \vert}^{2} {ⅇ}^{j 2 {α}_{N - 1}} = 0 \\ ⋮ \\ {\vert {b}_{m 0} \vert}^{2} + {\vert {b}_{m 1} \vert}^{2} {ⅇ}^{j ( N - 1 ) {α}_{1}} + {\vert {b}_{m 2} \vert}^{2} {ⅇ}^{j ( N - 1 ) {α}_{2}} + ⋯ + {\vert {b}_{mN - 1} \vert}^{2} {ⅇ}^{j ( N - 1 ) {α}_{N - 1}} = 0\end{matrix} \\ m = 0 , 1 ⋯ , M - 1.$$

28. A communication system, comprising:
a first communication unit configured to generate first spread data with a first code comprising [a₀, a₁e^{jkα}^{₁}, a₂e^{jkα}^{₂}, . . . , a_{N-1}e^{jkα}^{_{N-1}}], where [a₀, a₁, a₂, . . . , a_{N-1}] denotes a spread spectrum multiple access code, where α₁, α₂, . . . , α_{N-1} denote a plurality of rotation angles, and where k denotes a first integer.

29. The communication system of claim 28, wherein the first communication unit is configured to generate second spread data with a second code comprising [a₀₀, a₀₁e^{jmα}^{₁}, a₀₂e^{jmα}^{₂}, . . . , a_{0N-1}e^{jmα}^{_{N-1}}], where m denotes a second integer.

30. The communication system of claim 29, further comprising:
a second communication unit configured to receive the first spread data and to de-spread the first spread data with the first code.

31. The communication system of claim 30, further comprising:
a third communication unit configured to receive the second spread data and to de-spread the second spread data with the second code.

32. The communication system of claim 29, wherein the first communication unit comprises memory for storing the first code and for storing the second code.

33. The communication system of claim 29, wherein the first communication unit comprises a code generator for generating the first code and the second code.

34. The communication system of claim 30, where in the second communication unit comprises memory for storing the first code.

35. The communication system of claim 30, wherein the second communication unit comprises a code generator for generating th e first code.

36. A device for use in a communication network, the device comprising:
a memory unit having stored therein a pre-determined spread spectrum multiple access code comprising [a₀, a₁, a₂, . . . , a_{N-1}] and a plurality of pre-determined rotation angles comprising α₁, α₂, . . . , α_{N-1};
a code generator coupled to the memory unit and configured to generate a spread spectrum multiple access code comprising [a₀, a₁e^{jkα}^{₁}, a₂e^{jkα}^{₂}, . . . , a_{N-1}e^{jkα}^{_{N-1}}], where k denotes a pre-determined integer; and
a spreader circuit configured to receive data and to spread the received data with the spread spectrum multiple access code.

37. A device for use in a communication network, the device comprising:
a memory unit having stored therein a pre-determined spread spectrum multiple access code comprising [a₀, a₁, a₂, . . . , a_{N-1}] and a plurality of pre-determined rotation angles comprising α₁, α₂, . . . , α_{N-1};
a code generator coupled to the memory unit and configured to generate a spread spectrum multiple access code comprising [a₀, a₁e^{jkα}^{₁}, a₂e^{jkα}^{₂}, . . . , a_{N-1}e^{jkα}^{_{N-1}}], where k denotes a pre-determined integer; and
a de-spreader circuit configured to de-spread the demodulated data using the spread spectrum multiple access code.

38. A device for use in a communication network, the device comprising:
a memory unit having stored therein a pre-determined spread spectrum multiple access code comprising [a₀, a₁e^{jkα}^{₁}, a₂e^{jkα}^{₂}, . . . , a_{N-1}e^{jkα}^{_{N-1}}], where [a₀, a₁, a₂, . . . , a_{N-1}] denotes a pre-determined spread spectrum multiple access code, and where α₁, α₂, . . . , α_{N-1} denote a plurality of pre-determined rotation angles; and
a spreader circuit configured to receive data and to spread the received data with the spread spectrum multiple access code.

39. A device for use in a communication network, the device comprising:
a memory unit having stored therein a pre-determined spread spectrum multiple access code comprising [a₀, a₁e^{jkα}^{₁}, a₂e^{jkα}^{₂}, . . . , a_{N-1}e^{jkα}^{_{N-1}}], where [a₀, a₁, a₂, . . . , a_{N-1}] denotes a pre-determined spread spectrum multiple access code, and where α₁, α₂, . . . , α_{N-1} denote a plurality of pre-determined rotation angles; and
a de-spreader circuit configured to de-spread the demodulated data using the spread spectrum multiple access code.

40. A spread spectrum communication network configured to operate in a first pre-defined territory and a second pre-defined territory, the network comprising:
a first communication unit located in the first territory and configured to spread data using a first code of a first orthogonal code group B^{Tk} that includes M codes comprising
$$[ \begin{matrix}{b}_{0}^{{T}_{k}} \\ {b}_{1}^{{T}_{k}} \\ ⋮ \\ {b}_{M - 1}^{{T}_{k}}\end{matrix} ] ,$$
where bₘ^{T}^{ₖ}=[bₘ₀bₘ₁e^{jkα}^{₂}, bₘ₂e^{jkα}^{₂}, . . . , b_{mN-1}e^{jkα}^{_{N-1}}], where [bₘ₀, bₘ₁, bₘ₂, . . . , b_{mN-1}] denotes a base code, where k denotes an integer, and where in denotes an integer smaller than M−1; and
a second communication unit located in the second territory and configured to spread data using a second code of a second orthogonal code group B^{Tn} that includes a plurality of codes comprising
$$[ \begin{matrix}{b}_{0}^{{T}_{n}} \\ {b}_{1}^{{T}_{n}} \\ ⋮ \\ {b}_{M - 1}^{{T}_{n}}\end{matrix} ] ,$$
where bₘ^{T}^{ₙ}=[bₘ₀bₘ₁e^{jnα}^{₂}, bₘ₂e^{jnα}^{₂}, . . . , b_{mN-1}e^{jnα}^{_{N-1}}] and where n denotes an integer different from k.

41. The spread spectrum communication network of claim 40, further comprising a third communication unit located in the first territory and configured to spread data using a third code of first orthogonal code group B^{Tk}.

42. The spread spectrum communication network of claim 41, further comprising a fourth communication unit located in the second territory and configured to spread data using a fourth code of the second orthogonal code group B^{Tn}.
